(19) United States
(12) Patent Application Publication
(10) Pub. No.: US 2025/0333855 A1
(43) Pub. Date: Oct. 30, 2025

(54) AMMONIA SYNTHESIS DEVICE AND AMMONIA SYNTHESIS METHOD USING THE SAME

(71) Applicant: SEOUL NATIONAL UNIVERSITY R&DB FOUNDATION, Seoul (KR)

(72) Inventors: Yun Jeong HWANG, Seoul (KR); Yeong Bae JEON, Seoul (KR); Dong Woo SHIN, Seoul (KR)

(21) Appl. No.: 19/188,343

(22) Filed: Apr. 24, 2025

(30) Foreign Application Priority Data
Apr. 26, 2024 (KR) 10-2024-0056324

(51) Int. Cl. C25B 1/27; C01C 1/02; C25B 11/02; C25B 11/091

(52) U.S. Cl. CPC C25B 1/27; C01C 1/02; C25B 11/02; C25B 11/091

(57) ABSTRACT

Provided herein is an ammonia synthesis device including an electrode unit including a first electrode and a second electrode that have opposite polarities, and an electrolyte in which at least a portion of the electrode unit is immersed, wherein the electrolyte includes an organic solvent, a lithium salt, and a medium that provides protons, and at least a portion of the first electrode includes silver through galvanic replacement, or the electrolyte further includes a silver salt

### CROSS-REFERENCE TO RELATED APPLICATION

This application is based on and claims priority under 35 U.S.C. § 119 to Korean Patent Application No. 10-2024-0056324, filed on Apr. 26, 2024, in the Korean Intellectual Property Office, the disclosure of which is incorporated by reference herein in its entirety.

### BACKGROUND

### 1. Field

The present disclosure relates to an ammonia synthesis device and an ammonia synthesis method using the same.

### 2. Description of the Related Art

Providing sufficient food and energy for the rapidly growing world population remains humanity's ongoing challenge. New technology for dinitrogen (N₂) fixation to form ammonia (NH₃) offers a potential solution to these two problems. Synthetic ammonia-based fertilizers are already very crucial for global food production.

In addition, the high energy density of NH₃ provides promising prospects for use thereof as a transportable fuel or renewable energy carrier.

The Haber-Bosch method, which is most widely used to synthesize ammonia, proceeds by reacting nitrogen and hydrogen under high temperature and high pressure in the presence of an iron (Fe) catalyst. Meanwhile, since the bond energy of a nitrogen-nitrogen triple bond (N≡N) is much higher than other bonds, breaking the bond between nitrogen atoms and synthesizing ammonia require an enormous amount of energy. Fossil fuels used to supply this energy cause the emission of large amounts of greenhouse gases at a rate of 1.8 tons of CO₂ per ton of NH₃.

### SUMMARY

The present disclosure provides an ammonia synthesis device capable of improving ammonia synthesis efficiency and improving energy efficiency, and an ammonia synthesis method using the same.

An embodiment of the present disclosure provides an ammonia synthesis device including an electrode unit including a first electrode and a second electrode that have opposite polarities, and an electrolyte in which at least a portion of the electrode unit is immersed, wherein the electrolyte includes an organic solvent, a lithium salt, and a medium that provides protons, and at least a portion of the first electrode includes silver through galvanic replacement, or the electrolyte further includes a silver salt.

In an embodiment, only a portion of the first electrode which is immersed in the electrolyte may be galvanically replaced with silver.

In an embodiment, a concentration of the silver salt added to the electrolyte may be in a range of about 10 μM to about 8,000 μM.

In an embodiment, the first electrode may include at least any one of copper, nickel, molybdenum, titanium, or stainless steel.

In an embodiment, the electrode unit may further include a reference electrode for measuring the reduction potential of lithium.

Another embodiment of the present disclosure provides an ammonia synthesis method including supplying nitrogen into an electrolyte, applying a voltage to an electrode unit that is at least partially immersed in the electrolyte, and reducing the nitrogen with the applied voltage to produce ammonia, wherein at least a portion of a first electrode of the electrode unit includes silver through galvanic replacement, or the electrolyte further includes a silver salt.

In an embodiment, only a portion of the first electrode which is immersed in the electrolyte may be galvanically replaced with silver.

In an embodiment, a concentration of the silver salt added to the electrolyte may be in a range of about 10 μM to about 8,000 μM.

In an embodiment, the first electrode may include at least any one of copper, nickel, molybdenum, titanium, or stainless steel.

In an embodiment, in the application of the voltage, a first layer including silver and lithium may be formed, and a second layer including LiF may be formed on the first layer.

Additional aspects, features, and advantages of the present disclosure in addition to those described above will become apparent from the accompanying drawings, the claims, and the detailed description of the disclosure.

### BRIEF DESCRIPTION OF THE DRAWINGS

FIG. 1 is a cross-sectional view schematically illustrating an example of an ammonia synthesis device according to an embodiment of the present disclosure;

FIG. 2 is a flowchart schematically illustrating an example of an ammonia synthesis method according to an embodiment of the present disclosure;

FIG. 3 is a cross-sectional view illustrating a change in the surface of a first electrode during an ammonia synthesis process;

FIGS. 4 and 5 are graphs each showing changes in Faradaic efficiency when a silver salt is added to an electrolyte in the ammonia synthesis device of FIG. 1;

FIG. 6 is a graph showing changes in Faradaic efficiency when a silver salt is added to an electrolyte in the ammonia synthesis device of FIG. 1;

FIG. 7 is a graph showing an XPS depth-profile of silver;

FIG. 8 is a graph showing an XPS depth-profile of the surface of a first electrode during an ammonia synthesis process according to an embodiment of the present disclosure;

FIG. 9 is a graph showing the results of XRD of the surface of a first electrode during an ammonia synthesis process according to an embodiment of the present disclosure;

FIG. 10 is a graph showing the results of ToF-SIMS of the surface of a first electrode during an ammonia synthesis process according to an embodiment of the present disclosure;

FIG. 11 is a cross-sectional view schematically illustrating a method of galvanically replacing at least a portion of a first electrode with silver;

FIG. 12 is a graph showing changes in Faradaic efficiency when at least a portion of a first electrode of the ammonia synthesis device of FIG. 1 is galvanically replaced with silver; and

FIG. 13 is a graph showing reductions in overvoltage, according to an embodiment of the present disclosure.

### DETAILED DESCRIPTION

Advantages and features, and methods of achieving the same of the disclosure will become apparent from embodiments described below in detail with reference to the accompanying drawings. However, the present disclosure is not limited to the embodiments set forth herein, and may be embodied in many different forms. Also, it is to be appreciated that all changes, equivalents, and substitutes that do not depart from the spirit and technical scope of the present disclosure are encompassed in the present disclosure. Embodiments set forth below are provided so that the present disclosure is thorough and complete, and will fully convey the scope of the disclosure to those of ordinary skill in the art to which the present disclosure pertains. In the description of the present disclosure, detailed descriptions of the related art are omitted when it is deemed that they may unnecessarily obscure the essence of the present disclosure.

Terms used in the present application are used only to describe specific embodiments and are not intended to limit the present disclosure. An expression in the singular includes an expression in the plural unless the content clearly indicates otherwise. In the application, it should be understood that terms, such as “include” and “have”, are used to indicate the presence of stated features, numbers, steps, operations, elements, parts, or a combination thereof without excluding in advance the possibility of the presence or addition of one or more other features, numbers, steps, operations, elements, parts, or combinations thereof.

All terms used herein including technical or scientific terms have the same meaning as those generally understood by those of ordinary skill in the art to which the present disclosure pertains unless otherwise defined. It should be understood that terms generally used, which are defined in a dictionary, have the same meaning as in the context of the related art, and the terms are not interpreted with an ideal or excessively formal meaning unless otherwise clearly defined in the present application.

Hereinafter, embodiments of the present disclosure will be described with reference to the accompanying drawings.

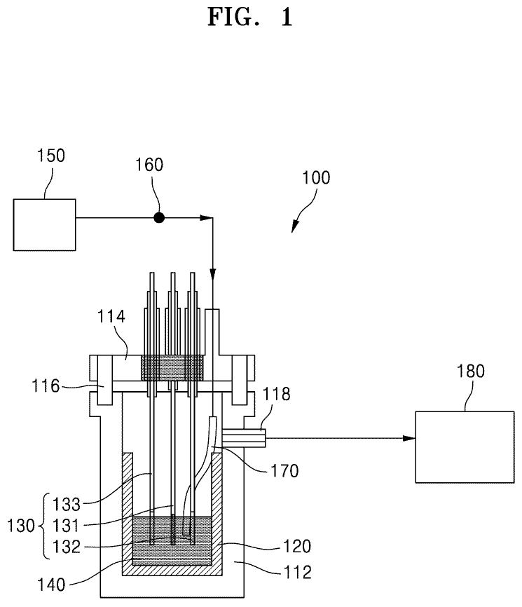

FIG. 1 is a cross-sectional view schematically illustrating an example of an ammonia synthesis device 100 according to an embodiment of the present disclosure.

Referring to FIG. 1, the ammonia synthesis device 100 according to an embodiment of the present disclosure may include an electrode unit 130 including a first electrode 131 and a second electrode 132 that have different polarities, a chamber 112 in which the electrode unit 130 is positioned, and an electrolyte 140 that is filled in the chamber 112 and in which at least a portion of the electrode unit 130 is immersed.

A voltage may be applied to the first electrode 131 and the second electrode 132 to synthesize ammonia.

The first electrode 131 may include at least any one of copper, nickel, molybdenum, titanium, or stainless steel.

Meanwhile, according to the present disclosure, at least a portion of the first electrode 131 may include silver through galvanic replacement, thereby improving ammonia synthesis efficiency and improving energy efficiency during ammonia synthesis.

The second electrode 132 is an electrode having a polarity opposite to that of the first electrode 131 and may include platinum (Pt).

The electrode unit 130 may further include a reference electrode 133.

The reference electrode 133 is an electrode for measuring the reduction potential of lithium and may include Pt.

The chamber 112 in which the electrode unit 130 is arranged needs to maintain a pressure required for ammonia synthesis. The chamber 112 may include a material with excellent strength, for example, stainless steel.

Meanwhile, the chamber 112 may be coupled to a cover 114 to isolate the space inside the chamber 112 from the outside. The cover 114 may be coupled to the chamber 112 via a connecting portion 116. The cover 114 may include the same material as the chamber 112.

An inner container 120 may be arranged inside the chamber 112. The electrolyte 140 is contained in the inner container 120, and the inner container 120 must have properties that do not chemically react with the electrolyte 140. For example, the inner container 120 may include, but is not limited to, Teflon.

The electrolyte 140 may include an organic solvent, a proton source required for synthesizing ammonia, and a fluorine (F)-containing Li salt.

Examples of organic solvents may include, but are not limited to, propylene carbonate, ethylene carbonate, dimethyl carbonate, 1,3-dioxolane, dimethoxyethane, tetrahydrofuran, dimethylformamide, acetonitrile, N-methylpyrrolidone, diethyl ether, diisopropyl ether, 1,4-dioxane, 2-methyltetrahydrofuran, tetrahydropyran, dibutyl ether, diethylene glycol dimethyl ether, isoamyl ether, tetraethylene glycol dimethyl ether and a combination thereof.

Examples of proton sources include, are not limited to, ethanol, 1-propanol, 2-methyl-1-propanol, tert-butyl alcohol, 2-butanol, 2-ethyl-1-butanol, 1-pentanol, 1-hexanol, 1-heptanol, 1-nonanol, benzyl alcohol, phenol, 1-phenylethanol, 2-phenylethanol, 2-chloroethanol, 2,2,2-trifluoroethanol, hexafluoro 2-propanol, glycerol, 1,3-butanediol, triethylene glycol, 1,5-pentanediol, acetic acid, hexanoic acid, allyl alcohol, 2-methoxyethanol, 1-propanethiol, methanol, cyclohexanol, 3-buten-1-ol, 1-butanol, 2-propanol, 3-methyl-1-butanol, and a combination thereof.

Examples of F-containing Li salts may include, but are not limited to, lithium bis(trifluoromethanesulfonyl)imide (LiTFSI), lithium difluoro(oxalato)borate (LiFOB), lithium bis(2,2-difluoro-1,3-dioxolane-4,5-bis(oxalato)borate) (LiDFOB), lithium hexafluorophosphate (LiPF₆), lithium bis(fluorosulfonyl)imide (LIFSI), lithium hexafluoroarsenate(V) (LiAsF₆), lithium tetrafluoroborate (LiBF₄), lithium trifluoromethanesulfonate (LiOTf), and lithium 2-trifluoromethyl-4,5-dicyanoimidazole (LiTDI).

Meanwhile, according to the present disclosure, the electrolyte 140 may further include a silver salt, resulting in improved ammonia synthesis efficiency, and improved energy efficiency during ammonia synthesis.

The ammonia synthesis device 100 may be connected to a nitrogen input unit 150 that supplies nitrogen. Nitrogen supplied from the nitrogen input unit 150 may pass through an impurity gas filter 160 and impurities may be removed therefrom.

Nitrogen from which impurities have been removed may be supplied into the electrolyte 140 through a tube 170. In an embodiment, an end of the tube 170 may be immersed in the electrolyte 140.

The tube 170 may have properties such as high temperature resistance, chemical resistance, insulation, and weather resistance. For example, the tube 170 may include, but is not limited to, a fluororesin tube.

The ammonia synthesis device 100 may be connected to a collection unit 180 that collects ammonia synthesized through a nitrogen reduction reaction. The synthesized ammonia may be collected in the collection unit 180 through an outlet 118 that may be connected to the chamber 112.

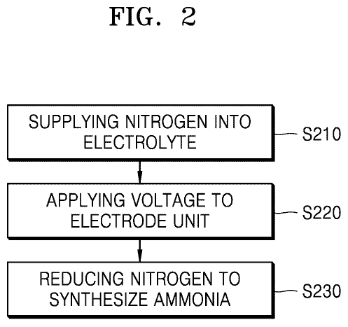

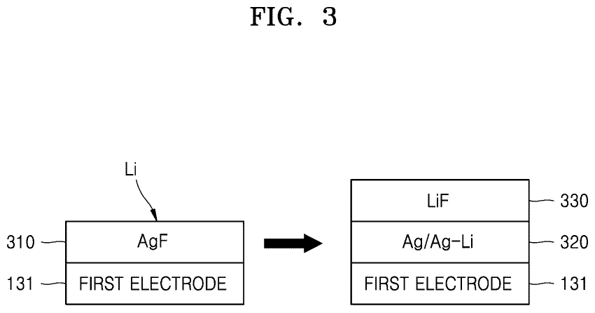

FIG. 2 is a flowchart schematically illustrating an example of an ammonia synthesis method according to an embodiment of the present disclosure, and FIG. 3 is a cross-sectional view illustrating a change in the surface of a first electrode during an ammonia synthesis process.

Referring to FIGS. 1 and 2 together, an ammonia synthesis method according to an embodiment of the present disclosure may include supplying nitrogen into an electrolyte (S210), applying a voltage to an electrode unit (S220), and reducing nitrogen to synthesize ammonia (S230).

The supply of the nitrogen into an electrolyte (S210) may be performed by passing nitrogen supplied from the nitrogen input unit 150 through the impurity gas filter 160 to remove impurities, followed by supply into the electrolyte 140 through the tube 170.

Subsequently, a voltage is applied to the electrode unit 130 including the first electrode 131, the second electrode 132, and the reference electrode 133 (S220).

The synthesis of the ammonia by reducing nitrogen (S230) is to synthesize ammonia through an electrochemical nitrogen reduction reaction using the supplied nitrogen, ions in the electrolyte 140, and the applied voltage.

Meanwhile, referring to FIG. 3 which illustrates a change in the surface of a first electrode during an ammonia synthesis process, when the electrolyte further includes silver, as shown in Reaction Scheme below, silver and fluorine (F) in the electrolyte may react to form a layer 310 including AgF on a surface of the first electrode 131.

Ag+F→AgF

Next, when the layer 310 including AgF reacts with lithium (Li) in the electrolyte, a first layer 320 including Ag and Li may be formed on the surface of the first electrode 131, and a second layer 330 including LiF may be formed on the first layer 320. For example, the first layer 320 may be an Ag/Ag-Li (alloy) layer, and the second layer 330 may be a LiF-containing layer. When the first layer 320 is an Ag/Ag-Li layer and the second layer 330 is a LiF layer, the reaction mechanism for forming the first layer 320 and the second layer 330 is as follows:

AgF+Li→Ag+LiF

Ag+Li→Ag−Li

Meanwhile, a thickness of the second layer (330) including LiF formed through the above reaction mechanism may be greater than a thickness when formed by a simple reaction between Li and F. As such, when the formed LiF layer has a large thickness, as in experimental results which will be described below, ammonia synthesis efficiency may be improved, and overvoltage may be reduced during ammonia synthesis, resulting in improved energy efficiency.

Hereinafter, the present disclosure will be described in further detail through the following examples. These examples are provided for illustrative purposes only to aid in understanding the present disclosure and are not intended to limit the scope of the present disclosure.

### EXAMPLE 1

An electrolyte used in Example 1 was a solution prepared by adding 2 M Lithium bis(trifluoromethanesulfonyl)imide (LiTFSI) salt and additionally adding 100 μM Silver bis(trifluoromethane)sulfonimide (AgTFSI) salt, to tetrahydrofuran (THF) solvent containing 1 vol % ethanol.

A copper foil electrode was used as a first electrode, a Pt foil electrode was used as a second electrode, and a Pt electrode was used as a reference electrode.

Ammonia synthesis was carried out in a single compartment cell made of stainless steel capable of withstanding high pressure, using 30 ml of an electrolyte, 20 atm of nitrogen, a first electrode having an area of 1 cm², and a second electrode having an area of 1.5 cm², and a constant current was applied at a current density of −55 mA/cm² for 1 hour by using a three-electrode system (first electrode, second electrode, and reference electrode) connected to a potentiostat, to synthesize ammonia.

### EXAMPLE 2

In Example 2, ammonia was synthesized in the same manner as in Example 1, except that a solution including the AgTFSI salt added to the electrolyte at a concentration of 50 μM was used as an electrolyte.

### EXAMPLE 3

In Example 3, ammonia was synthesized in the same manner as in Example 1, except that a solution including the AgTFSI salt added to the electrolyte at a concentration of 200 μM was used as an electrolyte.

### EXAMPLE 4

In Example 4, ammonia was synthesized in the same manner as in Example 1, except that a solution including the AgTFSI salt added to the electrolyte at a concentration of 400 μM was used as an electrolyte.

### COMPARATIVE EXAMPLE

In Comparative Example, ammonia was synthesized in the same manner as in Example 1, except that a solution in which the AgTFSI salt was not further added to the electrolyte was used as an electrolyte.

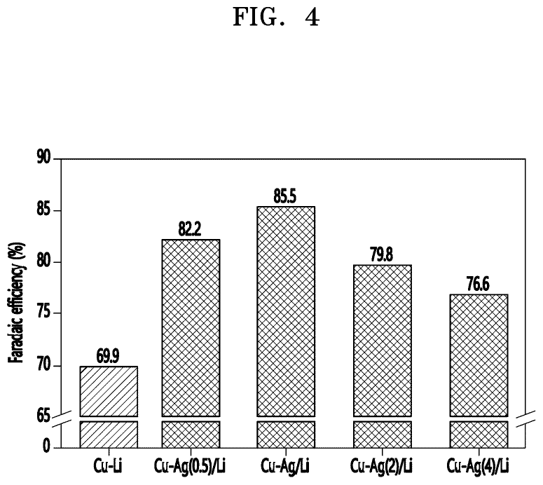

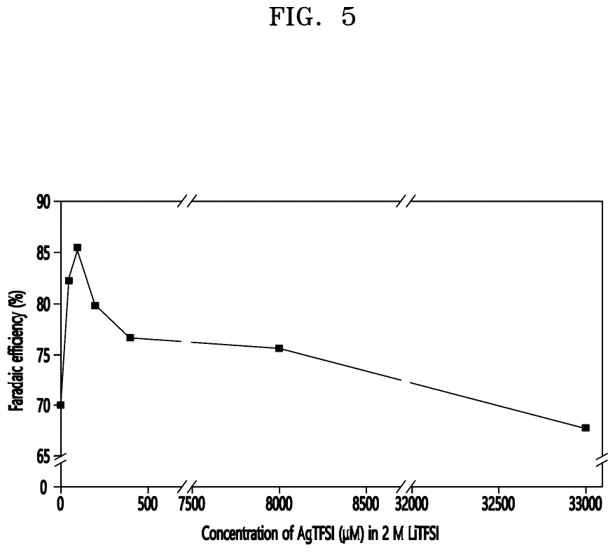

FIGS. 4 and 5 are graphs each showing changes in Faradaic efficiency when a silver salt is added to an electrolyte of the ammonia synthesis device of FIG. 1.

Referring to FIG. 4, on the x-axis, Cu—Li represents Comparative Example, Cu—Ag(0.5)/Li represents Example 2, Cu—Ag/Li represents Example 1, Cu—Ag(2)/Li represents Example 3, and Cu-Ag(4)/Li represents Example 4.

The y-axis of the graph represents Faradaic efficiency, which is 69.9% for Comparative Example, 82.2% for Example 2, 85.5% for Example 1, 79.8% for Example 3, and 76.6% for Example 4.

Thus, it can be seen that, when the silver salt (AgTFSI) is further added to the electrolyte, the Faradaic efficiency increases.

Referring to FIG. 5, the x-axis represents the concentration of further added silver salt (AgTFSI), and the y-axis represents Faradaic efficiency.

The Faradaic efficiency of Comparative Example in FIG. 4 was 69.9%. In the case of further adding the silver salt to the electrolyte, Faradaic efficiency is greater than at least 75% when the concentration of the silver salt is in a range of 10 μM to 8,000 μM. Thus, it can be seen that, when the silver salt is further added to the electrolyte, the Faradaic efficiency greatly increases compared to Comparative Example.

Meanwhile, the optimal Faradaic efficiency was shown in the electrolyte of Example 1 where the concentration of AgTFSI was 100 μM.

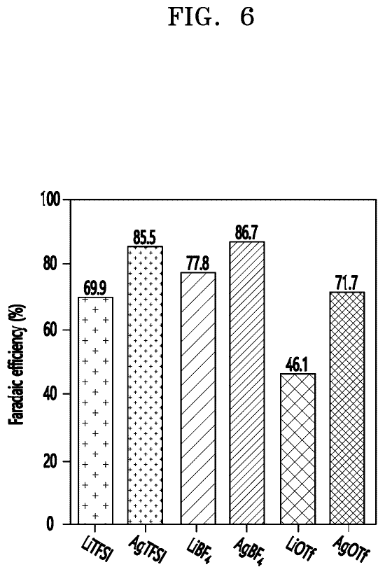

FIG. 6 is a graph showing changes in Faradaic efficiency when a silver salt is added to an electrolyte of the ammonia synthesis device of FIG. 1.

Referring to FIG. 6, the x-axis represents the type of salt added to the electrolyte, and the y-axis represents the Faradaic efficiency.

On the x-axis, LiTFSI is Comparative Example, and AgTFSI is Example 1.

Lithium tetrafluoroborate (LiBF₄) on the x-axis is a solution in which ammonia was synthesized in the same manner as in Comparative Example, except that 2 M LiBF₄ was added to the electrolyte instead of 2 M LiTFSI.

Lithium trifluoromethanesulfonate (LiOTf) on the x-axis is a solution in which ammonia was synthesized in the same manner as in Comparative Example, except that 2 M LiOTf was added to the electrolyte instead of 2 M LiTFSI.

Silver tetrafluoroborate (AgBF₄) on the x-axis is a solution in which ammonia was synthesized using the same method as that used for LiBF₄, but 100 μM AgBF₄ was further added to the electrolyte.

Silver trifluoromethanesulfonate (AgOTf) on the x-axis is a solution in which ammonia was synthesized using the same method as that used for LiOTf, but 100 μM AgOTf was further added to the electrolyte.

Comparing the Faradaic efficiencies of LiTFSI of Comparative Example and AgTFSI of Example 1, the Faradaic efficiency of LiTFSI was 69.9% and the Faradaic efficiency of AgTFSI was 85.5%. Thus, it can be seen that adding silver salt results in an increase in Faradaic efficiency.

Comparing the Faradaic efficiencies of LiBF₄ and AgBF₄, the Faradaic efficiency of LiBF₄ is 77.8% and the Faradaic efficiency of AgBF₄ is 86.7%. Thus, it can be seen that adding silver salt results in an increase in Faradaic efficiency.

Comparing the Faradaic efficiencies of LiOTf and AgOTf, the Faradaic efficiency of LiOTf is 46.1% and the Faradaic efficiency of AgOTf is 71.7%. Thus, it can be seen that adding of silver salt results in an increase in Faradaic efficiency.

From the above results, it was confirmed that, when the silver salt was added to the electrolyte, there was an effect of increasing Faradaic efficiency not only in LiTFSI of Comparative Example but also in other lithium salts.

The reason for the increased Faradaic efficiency is analyzed to be due to the formation of a thicker LiF layer in a solid electrolyte interphase (SEI) layer formed on the surface of a first electrode, when ammonia synthesis reaction proceeds after introducing silver into a system.

In previous studies, the LiF layer of SEI has been known as a substance that increases the Faradaic efficiency in an electrochemical lithium-mediated nitrogen reduction reaction under non-aqueous conditions.

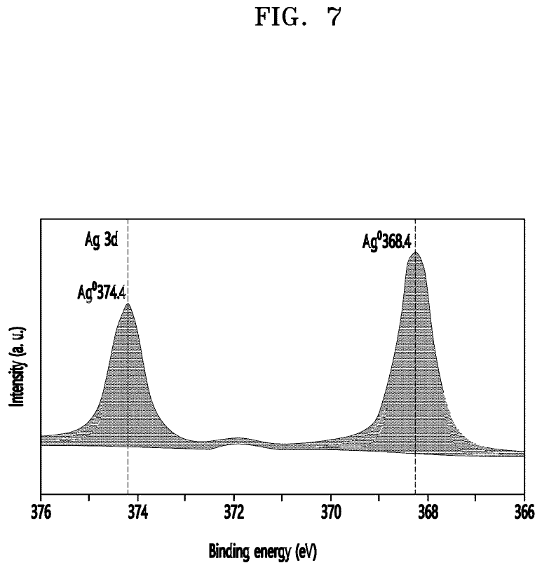

Hereinafter, the composition of the SEI layer and the thickness of the LiF layer will be described below with reference to FIGS. 7 to 10.

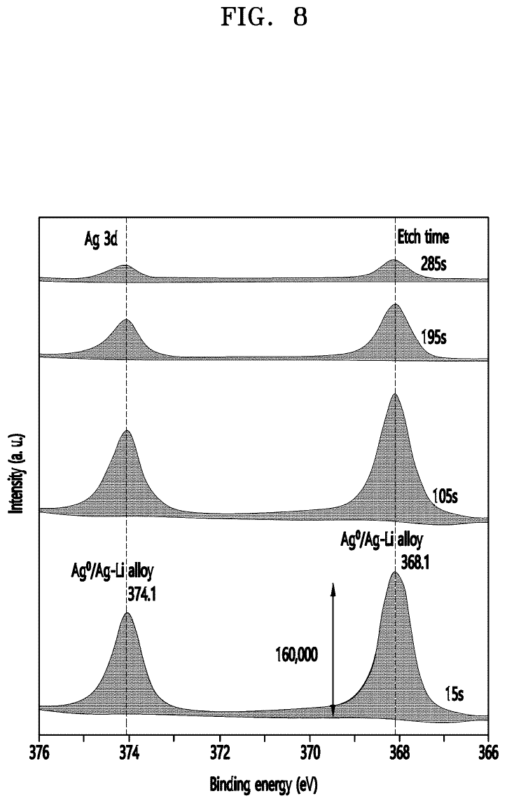

FIG. 7 is a graph showing an XPS depth-profile of silver, and FIG. 8 is a graph showing an XPS depth-profile of the surface of a first electrode during an ammonia synthesis process according to an embodiment of the present disclosure.

Referring to FIGS. 7 and 8, the XPS depth-profile of FIG. 8 illustrates the results of measurement of the surface of a first electrode during the ammonia synthesis process according to Example 1. The XPS depth-profile shows the measurement results of Ag 3d. Comparing both peaks of the Ag 3d graph, there is a difference between the peaks of a sample of silver itself (Ag⁰) and the graph showing the results of measurement of the surface of a first electrode during the ammonia synthesis process according to Example 1.

The peaks of the sample of silver itself (Ag⁰) are 374.4 ev and 368.4 ev, and the peaks of the surface of a first electrode during the ammonia synthesis process according to Example 1 are 374.1 ev and 368.1 ev.

From these results, it can be seen that the silver included on the surface of the first electrode during the ammonia synthesis process according to Example 1 exists not as silver itself (Ag⁰), but as an Ag⁰+Ag—Li alloy.

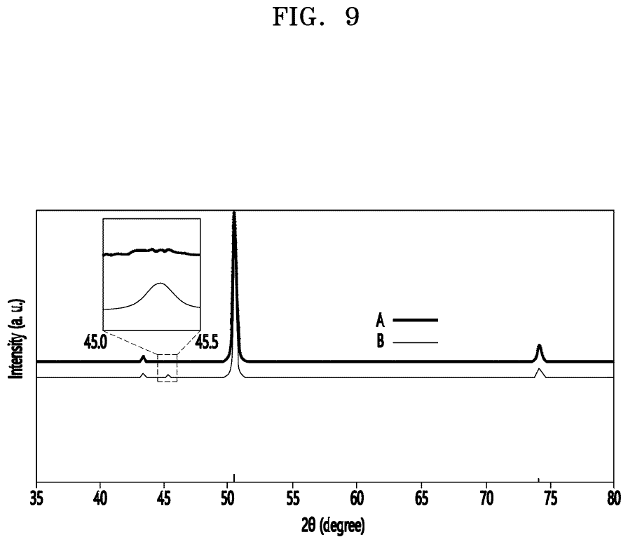

FIG. 9 is a graph showing the results of XRD of the surface of a first electrode during an ammonia synthesis process according to an embodiment of the present disclosure.

Referring to FIG. 9, A represents LiF detected on the surface of the first electrode during the ammonia synthesis process according to Comparative Example.

B represents LIF detected on the surface of the first electrode during the ammonia synthesis process according to Example 1.

XRD analysis is an analysis method that diffracts X-rays onto a desired specimen and represents information inside the specimen in a graph.

At around 45.3 degrees from the x-axis, the intensity of LiF can be seen to be greater for B than for A.

From these results, it can be seen that LiF exists more in Example 1 where silver was introduced.

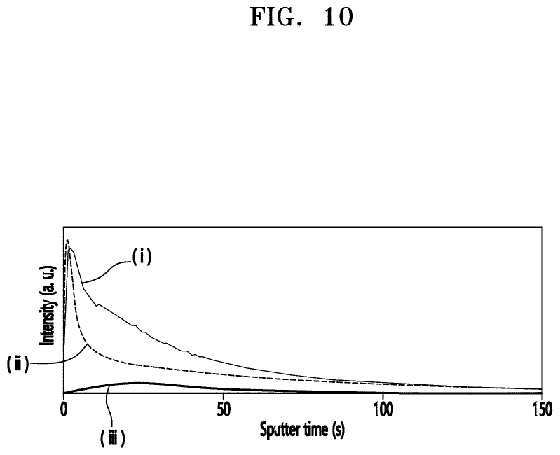

FIG. 10 is a graph showing the results of ToF-SIMS of the surface of a first electrode during an ammonia synthesis process according to an embodiment of the present disclosure.

Referring to FIG. 10, (i) represents LiF detected on the surface of the first electrode during the ammonia synthesis process according to Example 1.

(ii) represents LIF detected on the surface of the first electrode during the ammonia synthesis process according to Comparative Example.

(iii) represents silver (Ag) detected on the surface of the first electrode during the ammonia synthesis process according to Example 1.

The x-axis represents the sputtering time, and the y-axis represents the intensity of the detected component. As the sputtering time increases, the intensity of LiF in (i) decreases more slowly than in (ii).

Through these results, it can be seen that a layer including LiF on the surface of the first electrode during the ammonia synthesis process according to Example 1 is formed thicker than a layer including LiF on the surface of the first electrode during the ammonia synthesis process according to Comparative Example.

In addition, comparing (i) and (iii), the peak of the intensity of silver appears later than the peak of the intensity of LiF, from which it can be seen that the layer including silver is below the layer including LiF.

From these results, it can be seen that the layer including LiF is formed on the layer including silver, the layers being on the surface of the first electrode during the ammonia synthesis process according to Example 1.

Also, it can be seen that the layer including LiF was formed thicker on the surface of the first electrode during the ammonia synthesis process according to Example 1 than on the surface of the first electrode during the ammonia synthesis process according to Comparative Example.

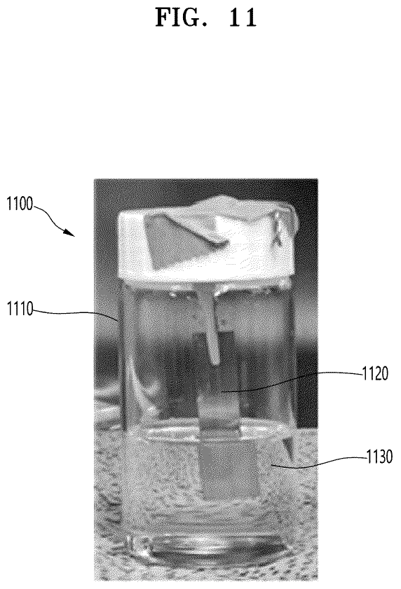

FIG. 11 is a cross-sectional view schematically illustrating a method of galvanically replacing at least a portion of a first electrode with silver.

Referring to FIG. 11, gAgCu (Cu foil galvanically replaced with Ag) was produced through galvanic replacement by immersing copper foil 1120 in a solution 1130 containing silver for 1 hour in a glove box 1110 having an argon atmosphere formed therein.

The solution 1130 containing silver was a solution prepared by further adding 400 μM Silver bis(trifluoromethanesulfonyl)imide (AgTFSI) to an electrolyte in which 2 M Lithium bis(trifluoromethanesulfonyl)imide (LiTFSI) was dissolved in a tetrahydrofuran (THF) solvent containing 1 vol % ethanol.

The galvanic replacement time and the solution containing silver are not limited to those in the above method, and any method for introducing silver to an electrode through galvanic replacement is possible.

When silver is introduced into the first electrode through galvanic replacement, the first electrode becomes a gAgCu electrode.

### EXAMPLE 5

In Example 5, ammonia was synthesized in the same manner as in Comparative Example, except that gAgCu was used as the first electrode instead of copper foil.

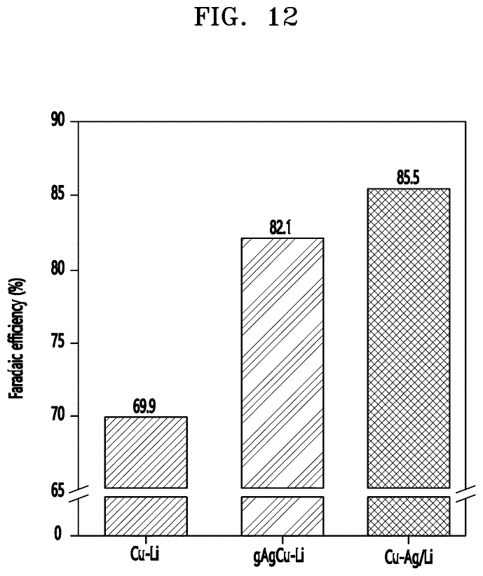

FIG. 12 is a graph showing changes in Faradaic efficiency when at least a portion of a first electrode of the ammonia synthesis device of FIG. 1 is galvanically replaced with silver.

Referring to FIG. 12, on the x-axis, Cu—Li represents Comparative Example, gAgCu—Li represents Example 5, Cu—Ag/Li represents Example 1.

The y-axis of the graph represents the Faradaic efficiency, which is 69.9% for Comparative Example, 82.1% for Example 5, and 85.5% for Example 1.

Thus, it can be seen that, when at least a portion of the first electrode is galvanically replaced with silver, the Faradaic efficiency increases.

It was also confirmed that, when at least a portion of the first electrode was galvanically replaced with silver, there was an effect similar to that of Example 1 where the silver salt was further added to the electrolyte.

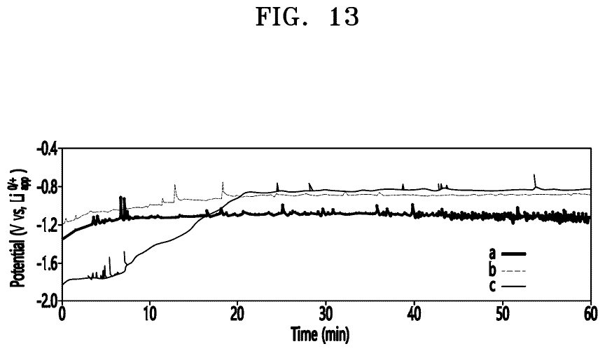

FIG. 13 is a graph showing reductions in overvoltage, according to an embodiment of the present disclosure.

Referring to FIG. 13, a represents the results of measuring the overvoltage of Comparative Example, b represents the results of measuring the overvoltage of Example 5, and c represents the results of measuring the overvoltage of Example 1.

Referring to the results, the overvoltage of b converges to around −0.8 V, and the overvoltage of c converges to around −0.8 V. The overvoltage of A converges to around −1.2 V.

Thus, when the silver salt is added to the electrolyte or when at least a portion of the first electrode is galvanically replaced with silver, overvoltage may be reduced, resulting in improved energy efficiency.

As such, in the present disclosure, by galvanically replacing at least a portion of a first electrode in a nitrogen reduction system with silver or further including a silver salt in an electrolyte, ammonia synthesis efficiency may be improved, and energy efficiency may be improved.

According to embodiments of the present disclosure, ammonia synthesis efficiency may be improved, and energy efficiency may be improved due to reduced overvoltage during ammonia synthesis.

Steps constituting a method according to the present disclosure may be performed in any suitable order unless otherwise explicitly indicated herein or otherwise clearly contradicted by context. The present disclosure is not necessarily limited to the described order of the steps. The use of any and all examples, or exemplary languages (e.g., “such as”) described herein is merely to describe the present disclosure in detail, and these examples or exemplary languages are not intended to limit the scope of the present disclosure unless otherwise limited by the claims. Furthermore, it will be understood by one of ordinary skill in the art that numerous modifications, combinations and changes will be made according to design conditions and factors within the scope of the appended claims or equivalents thereto.

Therefore, the spirit of the present disclosure should not be limited to the embodiments described above, and not only the scope of the claims described below but also all scopes equivalent thereto or equivalently modified therefrom will fall within the scope of the spirit of the present disclosure.

What is claimed is:

1. An ammonia synthesis device comprising:
an electrode unit comprising a first electrode and a second electrode that have opposite polarities; and
an electrolyte in which at least a portion of the electrode unit is immersed,
wherein the electrolyte comprises an organic solvent, a lithium salt, and a medium that provides protons, and
at least a portion of the first electrode comprises silver through galvanic replacement, or the electrolyte further comprises a silver salt.

2. The ammonia synthesis device of claim 1, wherein only a portion of the first electrode which is immersed in the electrolyte is galvanically replaced with silver.

3. The ammonia synthesis device of claim 1, wherein a concentration of the silver salt added to the electrolyte is in a range of about 10 μM to about 8,000 μM.

4. The ammonia synthesis device of claim 1, wherein the first electrode comprises at least any one of copper, nickel, molybdenum, titanium, or stainless steel.

5. The ammonia synthesis device of claim 1, wherein the electrode unit further comprises a reference electrode for measuring the reduction potential of lithium.

6. An ammonia synthesis method comprising:
supplying nitrogen into an electrolyte;
applying a voltage to an electrode unit that is at least partially immersed in the electrolyte; and
reducing the nitrogen with the applied voltage to produce ammonia,
wherein at least a portion of a first electrode of the electrode unit comprises silver through galvanic replacement, or the electrolyte further comprises a silver salt.

7. The ammonia synthesis method of claim 6, wherein only a portion of the first electrode which is immersed in the electrolyte is galvanically replaced with the silver.

8. The ammonia synthesis method of claim 6, wherein a concentration of the silver salt added to the electrolyte is in a range of about 10 μM to about 8,000 μM.

9. The ammonia synthesis method of claim 6, wherein the first electrode comprises at least any one of copper, nickel, molybdenum, titanium, or stainless steel.

10. The ammonia synthesis method of claim 6, wherein, in the application of the voltage, a first layer comprising silver and lithium is formed, and a second layer comprising LiF is formed on the first layer.
